(19) United States
(12) Patent Application Publication
(10) Pub. No.: US 2004/0204033 A1
(43) Pub. Date: Oct. 14, 2004

(54) Communication device connected to a first and a second communication networks

(76) Inventor: Chia-Li Yang, Taipei (TW)

Correspondence Address: PRO-TECHTOR INTERNATIONAL, 20775 Norada Court, Saratoga, CA, 95070-3018, US

(21) Appl. No.: 10/277,275

(22) Filed: Oct. 17, 2002

(51) Int. Cl. H04Q 7/20; H04M 1/00; H04B 1/38

(52) U.S. Cl. 455/552.1; 455/450; 455/426.1

(57) ABSTRACT

The present invention relates to a communication device connected to a first and a second communication networks. The communication device comprises a first and a second communication terminals respectively connected to a first and a second communication networks for respectively transmitting first and second format data; a data processing device for processing data; an input device for receiving input data from a user; an output device for transmitting output data to the user; a selecting device for the user to select one of the first and second communication terminals so as to generate a selecting signal based on the selection made by the user and output the selecting signal to the data processing device; and a determining device for determining whether the data processing device receives data from one of the first and the second communication terminals so as to generate a determining signal based on the determining result and output the determining signal to the data processing device.

### BACKGROUND OF THE INVENTION

1. Field of the Invention

The present invention relates to a communication device, such as a mobile phone, and particularly, to a communication device connected to a first and a second communication networks.

2. Description of the Prior Art

In the prior art, the conventional communication devices are VoIP phones, fixed line phones and mobile phones.

Each kind of the communication devices has its advantages and drawbacks. A VoIP phone establishes a communication over an internet. Even when the VoIP phone communicates with another one in a long distance, the telephone rate is the same as a local phone rate. Therefore, the VoIP phone can provide a low rate in the case of long distance communication. However, the VoIP phone generally has considerable volume and weight, and is not portable. Although the VoIP phone can provide a low rate in the case of long distance communication, the application of the VoIP phone is limited because of its immobility.

The fixed line phone, namely, a traditional district phone, is the most common communication device. The fixed line phone is very popular and convenient, and it can have several extensions which makes it a necessary office facility. However, the fixed line phone is immobile, and its application is limited.

In the recent years, the mobile phone is more and more popular. Although the mobile phone rate is much more expensive than the local phone rate, it almost becomes a necessary communication device in the modern society. This is due to its mobility.

### SUMMARY OF THE INVENTION

Therefore, the objective of the present invention is to provide a communication device, such as a mobile phone, connected to a first and a second communication networks. When the mobile phone is connected to the first communication network, it will communicate with another mobile phone via a mobile phone network. At this time, it is used as an ordinary mobile phone, and the telephone rate is the same as the mobile phone rate. When the mobile phone is connected to the second communication network, it will communicate with a device, such as a VoIP phone, via an infrared ray network or a Blue Tooth network. At this time, the mobile phone is used as an output/input device of the VoIP phone, and the telephone rate is the same as the VoIP phone rate. In this case, the user can enjoy the mobility of the mobile phone and the low rate of the VoIP phone.

The communication device according to the present invention comprises a first communication terminal connected to a first communication network for transmitting first format data; a second communication terminal connected a second communication network for transmitting second format data; a data processing device connected to the first and second communication terminals for processing data; an input device connected to the data processing device for receiving input data from a user; an output device connected to the data processing device for transmitting output data to the user; a selecting device connected to the data processing device for the user to select one of the first and second communication terminals so as to generate a selecting signal based on the selection made by the user and output the selecting signal to the data processing device; and a determining device connected to the data processing device for determining whether the data processing device receives data from one of the first and the second communication terminals so as to generate a determining signal based on the determining result and output the determining signal to the data processing device.

These and other objectives of the present invention will no doubt become obvious to those of ordinary skill in the art after having read the following detailed description of the preferred embodiment, which is illustrated in the various figures and drawings.

### BRIEF DESCRIPTION OF THE DRAWINGS

FIG. 1 is a functional block diagram of a communication device according to the present invention.

FIG. 2 is a flowchart of the operating process of the communication device when the user establishes a communication by means of the communication device.

FIG. 3 is a flowchart of the operating process of the communication device when the communication device receives a request signal requesting for establishing a communication from the first or the second communication network.

### DETAILED DESCRIPTION OF THE PREFERRED EMBODIMENT

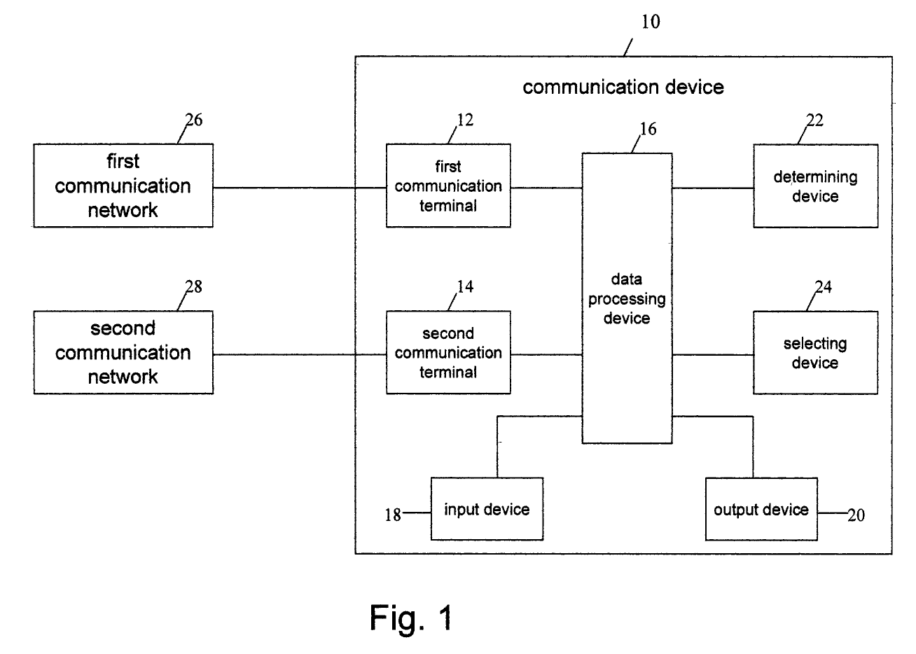

Please refer to FIG. 1. FIG. 1 is a functional block diagram of a communication device 10 according to the present invention. The communication device 10 comprises a first communication terminal 12, a second communication terminal 14, a data processing device 16, an input device 18, an output device 20, a determining device 22, and a selecting device 24. The first communication terminal 12 is connected to a first communication network 26 for transmitting first format data. The second communication terminal 14 is connected to a second communication network 28 for transmitting second format data. The data processing device 16 is connected to the first and second communication terminals 12, 14 for processing data. The input device 18 is connected to the data processing device 16 for receiving for receiving input data from a user. The output device 20 is connected to the data processing device 16 for transmitting output data to the user. The selecting, device 24 is connected to the data processing device 16 for the user to select the first or the second communication terminal 12 or 14 so as to generate a selecting signal based on the selection made by the user and output the selecting signal to the data processing device 16.

The determining device 22 is connected to the data processing device 16 for determining whether the data processing device 16 receives data from the first or the second communication terminal 12 or 14 so as to generate a determining signal based on the determining result and output the determining signal to the data processing device 16.

The communication device 10 can be a mobile phone. The first communication network 26 can be a mobile phone network to which a station (not shown) is connected. The first communication terminal 12 can be an antenna. The second communication network 28 can be an infrared ray communication network or a Blue Tooth communication network to which a VoIP phone or a fixed line phone is connected. The second communication terminal 14 can be an infrared ray communication terminal. The VoIP phone is connected to an internet, and the fixed line phone is connected to a fixed line phone network.

When the mobile phone 10 is connected to the mobile phone network, it can communicate with another mobile phone via the station. At this time, the mobile phone 10 is used as an ordinary mobile phone and the telephone rate follows the ordinary mobile phone rate.

When the mobile phone 10 is connected to the infrared ray communication network or Blue Tooth communication network, it can communicate with the VoIP phone or fixed line phone. The mobile phone 10 transmits data with the VoIP phone or fixed line phone by means of the infrared rays or Blue Tooth technology. At this time, the mobile phone 10 is used as an input/output device of the VoIP phone or fixed line phone. The mobile phone 10 can transmit data to the VoIP phone or fixed line phone so that the data can be transmitted via the internet or the fixed line phone network, and the mobile phone also can receive data from the VoIP phone or fixed line phone. The VoIP phone or fixed line phone needs to comprise the corresponding communication terminal for communicating with the mobile phone 10. At this time, the telephone rate of the mobile phone 10 follows the VoIP phone rate or the fixed line phone rate.

The input device 18 of the mobile phone 10 can be a microphone (namely, a megaphone) and a keyboard. The user can input voice data by using the microphone (the megaphone), and can input text data by using the keyboard. For example, the user can use the keyboard of the mobile phone 10 to input a telephone number, and this telephone number will be transmitted to the fixed line phone via the infrared rays or Blue Tooth technology, and the fixed line phone will dial this telephone number. After the communication is established, the user can speak to the microphone (megaphone), and the user's voice data will be transmitted to the fixed line phone, and then the fixed line phone will transmit this voice data via the fixed line phone network. Therefore, the mobile phone 10 is used as an extension of the fixed line phone.

The output device of the mobile phone 10 can be a speaker (namely, a handset) and a screen. The mobile phone 10 can output voice data by means of the speaker (handset), and can display text data by means of the screen. For example, when the fixed line phone receives a coming call of a telephone number, it can transmit this telephone number to the mobile phone 10, and the mobile phone 10 can display this telephone number by means of the screen. After the user answers the phone call and the communication is established, the fixed line phone will transmit the voice data received from the fixed line phone network to the mobile phone 10, and therefore, the user can hear this voice data by means of the speaker (handset) of the mobile phone 10.

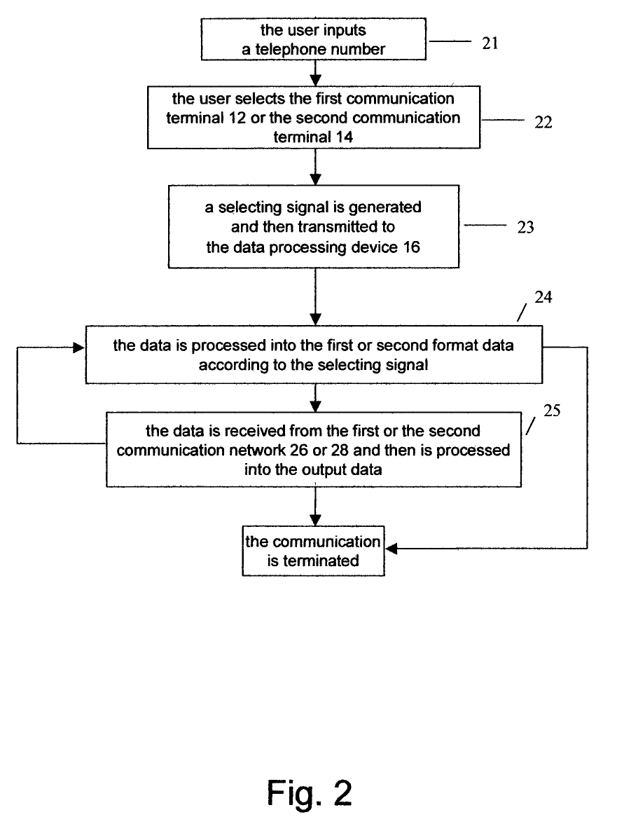

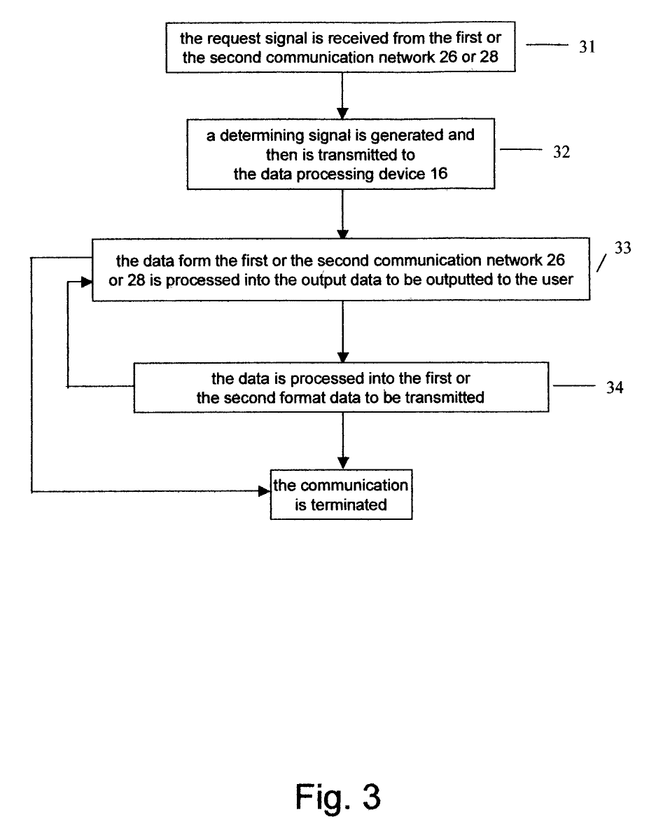

With reference to FIG. 2 and FIG. 3, the operating process of the communication device 10 will be described in details as follows Please refer to FIG. 2. FIG. 2 is a flowchart of the operating process of the communication device 10 when the user establishes a communication by means of the communication device 10. When the user starts a communication, for example, the user inputs a telephone number by means of the keyboard (refer to Step 21 of FIG. 2), the user can use the selecting device 24 to select the first communication terminal 12 or the second communication terminal 14. The selecting device 24 can be a computer program. The mobile phone 10 can display different options on the screen so that the user can select the first communication terminal 12 or the second communication terminal 14 (refer to Step 22 of FIG. 2). At this time, the selecting device 24 will generate a selecting signal according to the user's option, and output this selecting signal to the data processing device 16 (refer to Step 23 of FIG. 2).

When the user selects the first communication terminal 12 or the second communication terminal 14, the data processing device 16 will process input data inputted by the user into the first or second format data according to this selecting signal so as to transmit the data via the first communication network 26 or the second communication network 28 (refer to Step 24 of FIG. 2). And then the communication device 10 will receive the first or the second format data from the first or the second communication network 26 or 28 via the first or the second communication terminal 12 or 14 so that the data processing device 16 will process the first or the second format data into the output data and output the output data to the user via the output device 20 (refer to Step 25 of FIG. 2). The communication device 10 will execute Step 24 and Step 25 repeatedly until the communication is terminated.

When the communication device 10 is a mobile phone, the first communication network 26 is a mobile phone network, the first communication terminal 12 is an antenna, the second communication network 28 is a Blue Tooth communication network, and the second communication terminal 14 is a Blue Tooth communication terminal, the user can use the keyboard of the mobile phone 10 to input a telephone number, before the dialing, the user can select the first communication terminal 12 or the second communication terminal 14 (namely, the first communication network 26 or the second communication network 28) for communication.

When the user selects the first communication network 26, namely, the mobile phone network, for communication, the mobile phone 10 is used as a mobile phone.

When the user selects the second communication network 28, such as the Blue Tooth communication network, for communication, as mentioned above, the mobile phone 10 can communicate with the VoIP phone or the fixed line phone via the Blue Tooth communication network. Take the VoIP phone as an example. After the user makes the selection, the data processing device 16 of the mobile phone 10 will process this telephone number into the data format (namely, the second data format) capable of being transmitted by means of the Blue Tooth technology, and this telephone number will be transmitted to the VoIP phone via the second communication terminal 14 of the mobile phone 10 (namely, the Blue Tooth communication terminal) by means of the Blue Tooth technology. The VoIP phone will dial this telephone number. When the communication is established, the VoIP phone will transmit the voice data received from the internet to the second communication terminal 14 of the mobile phone 10 by means of the Blue Tooth technology. The data processing device 16 of the mobile phone 10 will process this voice data so as to output it to the user via the output device 20, such as the speaker.

Please refer FIG. 3. FIG. 3 is a flowchart of the operating process of the communication device 10 when the communication device 10 receives a request signal requesting for establishing a communication from the first or the second communication network 26 or 28.

When the communication device 10 receives the request signal from the first or the second communication network 26 or 28 (refer to Step 31 of FIG. 3), the determining device 22 will generate a determining signal according to this request signal, and output this determining signal to the data processing device 16 (refer to Step 32 of FIG. 3). The determining device 22 can be a computer program.

When the determining device 22 determines that this request signal is transmitted from the first or the second communication network 26 or 28, the data processing device 16 will process the first or the second format data from the first or the second communication network 26 or 28 into the output data according to the determining signal so as to output the output data to the user via the output device 20 (refer to Step 33 of FIG. 3). And then the data processing device 16 will process the input data inputted by the user via the input device 18 into the first or the second format data so as to transmit the first or the second format data via the first or the second communication network 26 or 28 (refer to Step 34 of FIG. 3). The communication device 10 will execute Step 33 and Step 34 repeatedly until the communication is terminated.

When the communication device 10 is a mobile phone, the first communication network 26 is a mobile phone network, the first communication terminal 12 is an antenna, the second communication network 28 is a Blue Tooth communication network, the second communication terminal 14 is a Blue Tooth communication terminal, and a fixed line phone is connected to the Blue Tooth communication network, and when the mobile phone 10 receives a coming call from another mobile phone via the mobile phone network, the determining device 24 will determine this phone call is from the first communication network 26. Therefore, the mobile phone 10 is used as an ordinary mobile phone.

When the mobile phone 10 receives the coming call from the fixed line phone via the Blue Tooth communication network, the determining device 24 will determine this phone call is from the second communication network 28, and the data processing device 16 will process the data format (namely, the second data format) transmitted from the fixed line phone by means of the Blue Tooth technology into the voice data, and output the voice data to the user via the speaker (handset). Besides, the data processing device 16 will process the voice data inputted by the user via the microphone (megaphone) into the second data format so as to transmit this data to the fixed line phone via the Blue Tooth communication network. And then the fixed line phone will transmit this data via the fixed line phone network. At this time, the mobile phone 10 is used as an extension of the fixed line phone.

It should be noticed that the communication device of the present invention is not limited to only comprise two communication terminals. For example, the mobile phone 10 can have three communication terminals. When the mobile phone 10 is connected to the first communication terminal, it is used as an ordinary mobile phone. When the mobile phone 10 is connected to the second communication terminal, it will communicate with a VoIP phone, and it is used as an input/output device of the VoIP phone. And when the mobile phone 10 is connected to the third communication terminal, it will communicate with a fixed line phone, and it is used as an extension of a fixed line phone.

Compared with the prior art, the communication device of the invention, such as a mobile phone, can communicate with other devices, such as a VoIP phone, a fixed line phone, so as to transmit data. Therefore, the user can enjoy not only the mobility of the mobile phone, but also the low telephone rate. Besides, the user can answer the phone calls from the VoIP phone and the fixed line phone by using the mobile phone of the invention. Therefore, the user can answer all of the office phone calls even when he or she is out of the office.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A communication device comprising:
a first communication terminal connected to a first communication network for transmitting first format data;
a second communication terminal connected a second communication network for transmitting second format data;
a data processing device connected to the first and second communication terminals for processing data;
an input device connected to the data processing device for receiving input data from a user;
an output device connected to the data processing device for transmitting output data to the user;
a selecting device connected to the data processing device for the user to select one of the first and second communication terminals so as to generate a selecting signal based on the selection made by the user and output the selecting signal to the data processing device; and
a determining device connected to the data processing device for determining whether the data processing device receiving data from one of the first and the second communication terminals so as to generate a determining signal based on the determining result and output the determining signal to the data processing device;
wherein after the user starts a communication, the user selects one of the first communication terminal and the second communication terminal by using the selecting device, wherein:
when the user selects the first communication terminal, the data processing device will process input data inputted by the user into the first format data according to the selecting signal so as to transmit the first format data via the first communication network, and then the communication device will receive the first format data from the first communication network via the first communication terminal so that the data processing device will process the first format data into the output data and output the output data to the user via the output device, and the communication device will repeat the transmitting and receiving until the communication is terminated;
and when the user selects the second communication terminal, the data processing device will process input data inputted by the user into the second format data according to the selecting signal so as to transmit the second format data via the second communication network, and then the communication device will receive the second format data from the second communication network via the second communication terminal so that the data processing device will process the second format data into the output data and output the output data to the user via the output device, and the communication device will repeat the transmitting and receiving until the communication is terminated;
wherein when the communication device receives a request signal from one of the first and the second communication networks requesting to establish a communication, the determining device will generate the determining signal according to the request signal, wherein:
when the determining device determines that the request signal is transmitted from the first communication network, the data processing device will process the first format data from the first communication network into the output data according to the determining signal so as to output the output data to the user via the output device, and process the input data inputted by the user via the input device into the first format data so as to transmit the first format data via the first communication network, and the communication device will repeat the transmitting and receiving until the communication is terminated;
and when the determining device determines that the request signal is transmitted from the second communication network, the data processing device will process the second format data from the second communication network into the output data according to the determining signal so as to output the output data to the user via the output device, and process the input data inputted by the user via the input device into the second format data so as to transmit the second format data via the second communication network, and the communication device will repeat the transmitting and receiving until the communication is terminated.

2. The communication device of claim 1, wherein the communication device is a mobile phone.

3. The communication device of claim 1, wherein the input device is a microphone.

4. The communication device of claim 1, wherein the input device is a keyboard.

5. The communication device of claim 1, wherein the output device is a speaker.

6. The communication device of claim 1, wherein the output device is a screen.

7. The communication device of claim 2, wherein the first communication network is a mobile phone network to which a station is connected so that the mobile phone can communicate with another mobile phone, and the second communication network is an infrared ray communication network to which a VoIP phone is connected to so that the mobile phone can communicate with the VoIP phone, wherein the VoIP phone is connected to an internet.

8. The communication device of claim 7, wherein the first communication terminal is an antenna, and the second communication terminal is an infrared ray communication terminal.

9. The communication device of claim 2, wherein the first communication network is a mobile phone network to which a station is connected so that the mobile phone can communicate with another mobile phone, and the second communication network is a Blue Tooth communication network to which a VoIP phone is connected to so that the mobile phone can communicate with the VoIP phone, wherein the VoIP phone is connected to an internet.

10. The communication device of claim 9, wherein the first communication terminal is an antenna, and the second communication terminal is a Blue Tooth communication terminal.

11. The communication device of claim 2, wherein the first communication network is a mobile phone network to which a station is connected so that the mobile phone can communicate with another mobile phone, and the second communication network is an infrared ray communication network to which a fixed line phone is connected to so that the mobile phone can communicate with the fixed line phone, wherein the fixed line phone is connected to a fixed line phone network.

12. The communication device of claim 11, wherein the first communication terminal is an antenna, and the second communication terminal is an infrared ray communication terminal.

13. The communication device of claim 2, wherein the first communication network is a mobile phone network to which a station is connected so that the mobile phone can communicate with another mobile phone, and the second communication network is a Blue Tooth communication network to which a fixed line phone is connected to so that the mobile phone can communicate with the fixed line phone, wherein the fixed line phone is connected to a fixed line phone network.

14. The communication device of claim 13, wherein the first communication terminal is an antenna, and the second communication terminal is a Blue Tooth communication terminal.
